(19) United States
(12) Patent Application Publication
(10) Pub. No.: US 2025/0265567 A1
(43) Pub. Date: Aug. 21, 2025

(54) TICKETING IN MESSAGING

(71) Applicant: Hollywood.com LLC, Boca Raton, FL (US)

(72) Inventor: Shane Alan Walker, Boca Raton, FL (US)

(21) Appl. No.: 19/056,054

(22) Filed: Feb. 18, 2025

Related U.S. Application Data
(60) Provisional application No. 63/554,755, filed on Feb. 16, 2024.

(51) Int. Cl. G06Q 20/32; G06Q 10/02

(52) U.S. Cl. CPC G06Q 20/3255; G06Q 10/02

(57) ABSTRACT

In various examples, system, methods, and techniques for implementing communication between a messaging application (e.g., a texting application) on a client device (e.g., a mobile device) and one or more different applications. In at least one embodiment, a server application transmits a link to a messaging application performed by a client device. Selection of the link in the messaging application causes the client device to launch an abbreviated version of a client application. The abbreviated version implements less than a full version of the client application. The abbreviated version of the client application transmits ticket selection information to the server application, and causes the messaging application to initiate a payment process.

### CROSS REFERENCE TO RELATED APPLICATION

This application claims the benefit of U.S. Provisional Patent Application No. 63/554,755, filed on Feb. 16, 2024, which is incorporated herein by reference in its entirety.

### TECHNICAL FIELD

The present invention is directed generally to using a messaging application (e.g., a texting application) to communicate with one or more other applications being performed by a client device (e.g., a mobile device). At least one embodiment pertains to using the messaging application to launch an abbreviated version (e.g., an App Clip) of another application.

### DESCRIPTION OF THE RELATED ART

The types of tasks performed by client devices, such as mobile devices, like cellular telephones, is ever increasing. In particular, client devices are frequently used to send electronic messages (e.g., texts). The capabilities of messaging applications (e.g., texting applications) used to send such electronic messages can be expanded and/or improved.

### BRIEF DESCRIPTION OF THE SEVERAL VIEWS OF THE DRAWING(S)

Various embodiments in accordance with the present disclosure will be described with reference to the following drawings.

FIG. 1 illustrates an example system that includes one or more App Clips that a user may use to purchase one or more tickets, in accordance with at least one embodiment.

FIG. 2 is a block diagram illustrating example communications used when the App Clip(s) is/are used to purchase tickets, in accordance with at least one embodiment.

FIG. 3 is a block diagram illustrating example communications used when a client application is used to purchase tickets, in accordance with at least one embodiment.

FIGS. 4A-4E illustrate example interfaces that may be displayed by the App Clip(s) to a user, in accordance with at least one embodiment. FIG. 4A is an illustration of an example of an initial interface, in accordance with at least one embodiment. FIG. 4B is an illustration of an example of a ticket selection interface, in accordance with at least one embodiment. FIG. 4C is an illustration of an example of a seat selection interface that includes a seat map, in accordance with at least one embodiment. FIG. 4D is an illustration of an example of a checkout interface, in accordance with at least one embodiment. FIG. 4E is an illustration of an example of an interface that displays a message to a user, in accordance with at least one embodiment.

FIG. 4F illustrates an example interface that may be displayed by a messaging application to a user, in accordance with at least one embodiment.

FIG. 4G illustrates an example interface that may be displayed by a payment application to a user, in accordance with at least one embodiment.

FIG. 5 depicts a first code segment that may be used to implement ticket purchasing using a messaging application implemented by a client device, in accordance with at least one embodiment.

FIG. 6 depicts a second code segment that may be used to implement ticket purchasing using a messaging application implemented by a client device, in accordance with at least one embodiment.

FIG. 7 depicts a third code segment that may be used to implement ticket purchasing using a messaging application implemented by a client device, in accordance with at least one embodiment.

FIG. 8 depicts a fourth code segment that may be used to implement ticket purchasing using a messaging application implemented by a client device, in accordance with at least one embodiment.

FIG. 9 depicts a fifth code segment that may be used to implement ticket purchasing using a messaging application implemented by a client device, in accordance with at least one embodiment.

FIG. 10 depicts a sixth code segment that may be used to perform these tasks, in accordance with at least one embodiment.

FIG. 11 depicts a seventh code segment that may be used to implement ticket purchasing using a messaging application implemented by a client device, in accordance with at least one embodiment.

FIG. 12 depicts an eighth code segment that may be used to implement ticket purchasing using a messaging application implemented by a client device, in accordance with at least one embodiment.

FIG. 13 depicts a nineth code segment that may be used to implement ticket purchasing using a messaging application implemented by a client device, in accordance with at least one embodiment.

FIG. 14 depicts a tenth code segment that may be used to perform these tasks, in accordance with at least one embodiment.

FIG. 15 depicts an eleventh code segment that may be used to implement ticket purchasing using a messaging application implemented by a client device, in accordance with at least one embodiment.

FIG. 16 depicts a twelfth code segment that may be used to implement ticket purchasing using a messaging application implemented by a client device, in accordance with at least one embodiment.

FIG. 17 depicts a thirteenth code segment that may be used to implement ticket purchasing using a messaging application implemented by a client device, in accordance with at least one embodiment.

FIG. 18 depicts a fourteenth code segment that may be used to implement ticket purchasing using a messaging application implemented by a client device, in accordance with at least one embodiment.

FIG. 19 depicts a fifteenth code segment that may be used to implement ticket purchasing using a messaging application implemented by a client device, in accordance with at least one embodiment.

FIG. 20 depicts a sixteenth code segment that may be used to implement ticket purchasing using a messaging application implemented by a client device, in accordance with at least one embodiment.

FIG. 21 depicts a seventeenth code segment that may be used to implement ticket purchasing using a messaging application implemented by a client device, in accordance with at least one embodiment.

FIG. 22 is a diagram of a hardware environment and an operating environment in which the computing devices of the system of FIG. 1 may be implemented.

Like reference numerals have been used in the figures to identify like components.

### DETAILED DESCRIPTION

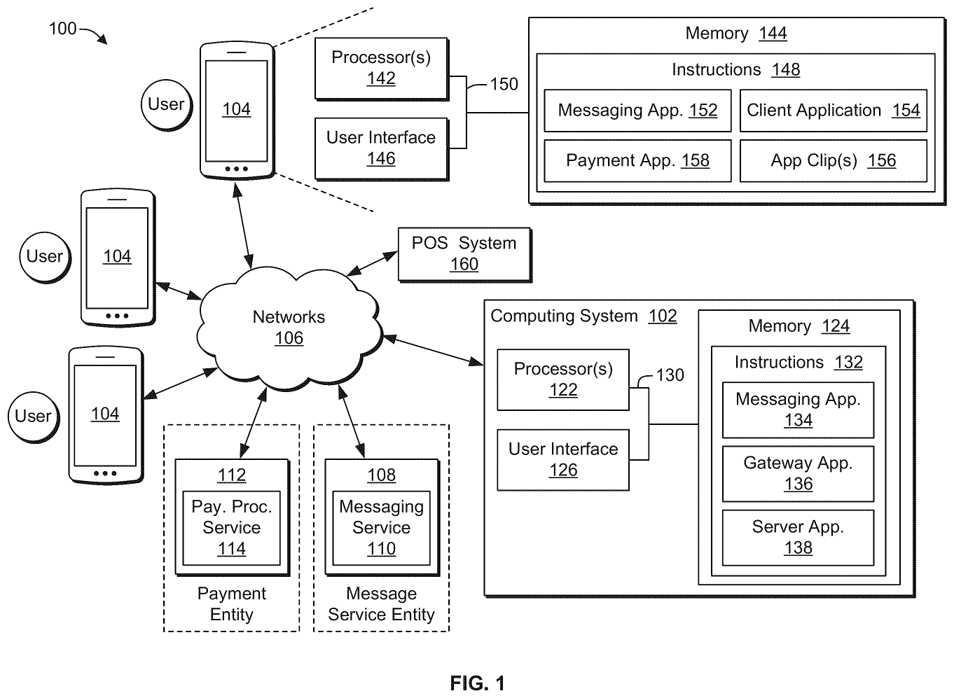

FIG. 1 illustrates a system 100 that includes one or more App Clips 156 that a user may use to purchase one or more tickets, in accordance with at least one embodiment. The ticket(s) may include one or more movie tickets, one or more event tickets, one or more entertainment tickets, and/or one or more other types of tickets. An “App Clip” is a component, portion, or abbreviated version of a client application 154 (e.g., a mobile application on iOS) that allows a user to perform one or more tasks without first installing (e.g., after downloading) the full client application 154. The system 100 includes a computing system 102 connected to one or more client devices 104 by one or more networks 106. The network(s) 106 may be connected to a computing system 108 implementing a messaging service 110 (e.g., operated by a message service entity). The computing system 102 and the client device(s) 104 may access the messaging service 110 via the network(s) 106. The network(s) 106 may be connected to a computing system 112 implementing a payment processing service 114 (e.g., operated by a payment entity). The computing system 102 and/or the client device(s) 104 may access the payment processing service 114 via the network(s) 106.

By way of a non-limiting example, the messaging service 110 may be implemented as an Apple Business Messaging Service that may be developed and maintained in a Webex Connect Platform, an IMI platform, and/or a Webex Communications Platform as a Service (“CPaaS”) platform. In such embodiments, the client application 154 may be implemented as an iOS application for Apple devices (e.g., iPhone, iPad, and/or the like), the messaging application 152 may be implemented as an Apple Messaging Application (e.g., iMessage), and the messaging application 134 may implement and/or be implemented as a Messaging Service Provider (“MSP”) server and/or platform.

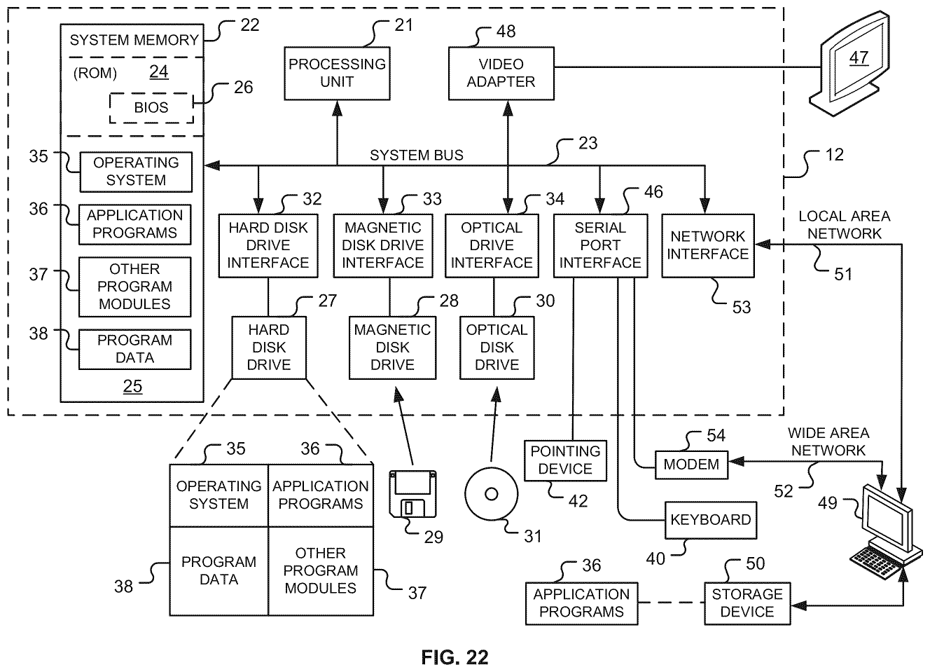

The computing system 102 may be implemented using one or more computing devices, such as a computing device 12 (see FIG. 22). The computing system 102 may include one or more processors 122, memory 124, and a user interface 126. The memory 124 (e.g., one or more non-transitory processor-readable medium) stores machine executable instructions 132 that when performed by processor(s) 122 implement a messaging application 134, a gateway application 136, and/or a server application 138.

The processor(s) 122 may include one or more circuits that perform at least a portion of the instructions 132 stored in the memory 124. The processor(s) 122 may include one or more parallel processing units (“PPU(s)”), such as one or more graphics processing units (“GPU(s)”), one or more massively parallel GPU(s), one or more accelerators, and/or others. The processor(s) 122 may be implemented, for example, using a main central processing unit (“CPU”) complex, one or more microprocessors, one or more microcontrollers, PPU(s) (e.g., accelerator(s), GPU(s), and/or others), one or more data processing units (“DPU(s)”), one or more arithmetic logic units (“ALU(s)”), and/or others. The memory 124 (e.g., one or more non-transitory processor-readable medium) may be implemented, for example, using volatile memory (e.g., dynamic random-access memory (“DRAM”)) and/or nonvolatile memory (e.g., a hard drive, a solid-state device (“SSD”), and/or others). The user interface 126 may include a display device (not shown) that a user may use to view information generated and/or displayed by computing system 102. In at least one embodiment, the user may use the user interface 126 to enter user input into the computing system 102. In at least one embodiment, referring to FIG. 1, the user interface 126 may communicate (e.g., wirelessly) with a user device (e.g., a cellular telephone, a laptop computer, a tablet, and/or others) and may receive user input from said user device. In at least one embodiment, the memory 124, the processor(s) 122, and/or the user interface 126 may communicate with one another over connection(s) 130, such as a bus, a Peripheral Component Interconnect Express (“PCIe”) connection (or bus), and/or others.

The client device(s) 104 may each be implemented using a computing device, such as the computing device 12 (see FIG. 22), a mobile device, a cellular telephone, a laptop computer, a tablet computer, and/or the like. The client device(s) 104 may include one or more processors 142, memory 144, and a user interface 146. The memory 144 (e.g., one or more non-transitory processor-readable medium) stores machine executable instructions 148 that when performed by processor(s) 142 implement a messaging application 152, a client application 154, and/or a payment application 158.

The processor(s) 142 may include one or more circuits that perform at least a portion of the instructions 148 stored in the memory 144. The processor(s) 142 may include one or more PPUs, such as one or more GPUs, one or more massively parallel GPU(s), one or more accelerators, and/or others. The processor(s) 142 may be implemented, for example, using a main CPU complex, one or more microprocessors, one or more microcontrollers, PPU(s) (e.g., accelerator(s), GPU(s), and/or others), one or more DPUs, one or more ALUs, and/or others. The memory 144 (e.g., one or more non-transitory processor-readable medium) may be implemented, for example, using volatile memory (e.g., DRAM) and/or nonvolatile memory (e.g., a hard drive, a SSD, and/or others). The user interface 146 may include a display device (not shown) that a user may use to view information generated and/or displayed by the client device(s) 104. In at least one embodiment, the user may use the user interface 146 to enter user input into the client device(s) 104. In at least one embodiment, referring to FIG. 1, the user interface 146 may communicate (e.g., wirelessly) with a user device (e.g., a cellular telephone, a laptop computer, a tablet, and/or others) and may receive user input from said user device. In at least one embodiment, the memory 144, the processor(s) 142, and/or the user interface 146 may communicate with one another over connection(s) 150, such as a bus, a PCIe connection (or bus), and/or others.

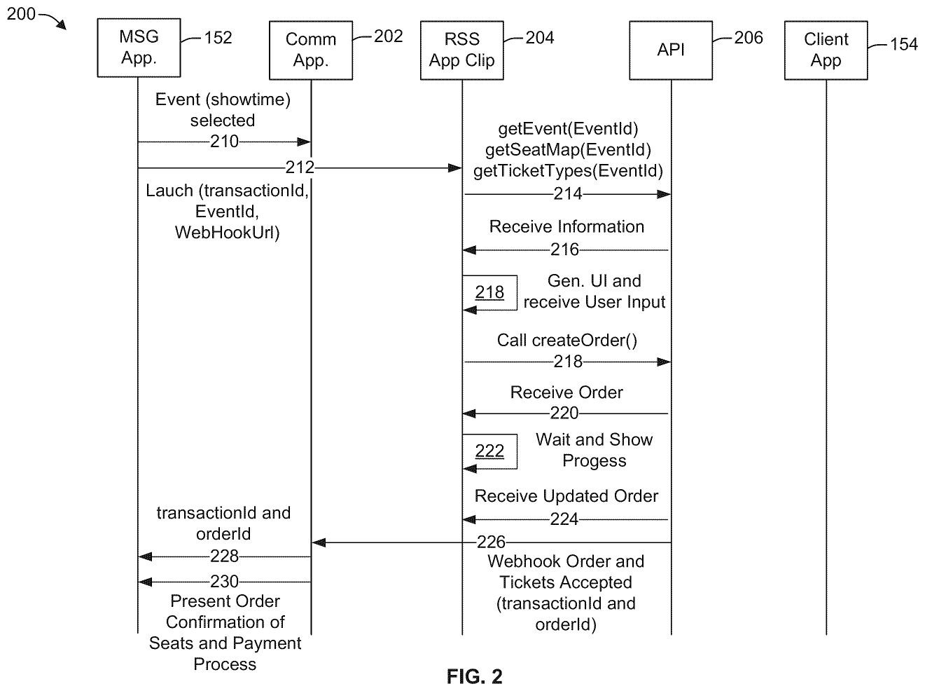

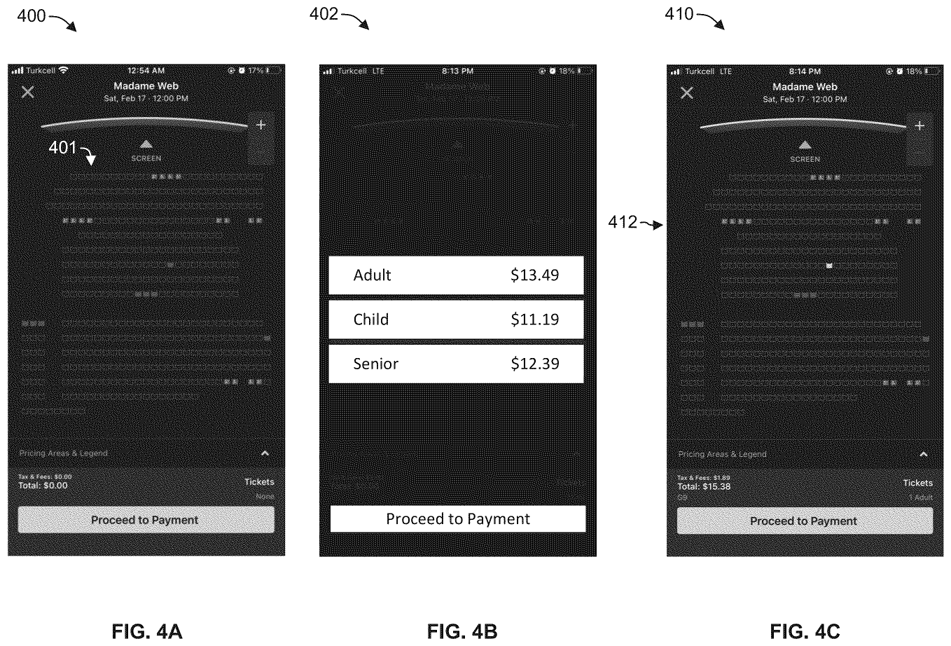

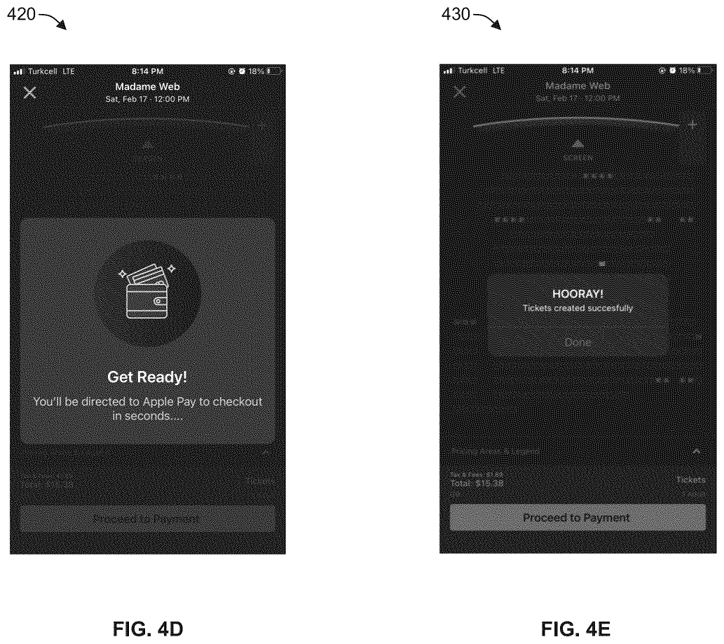

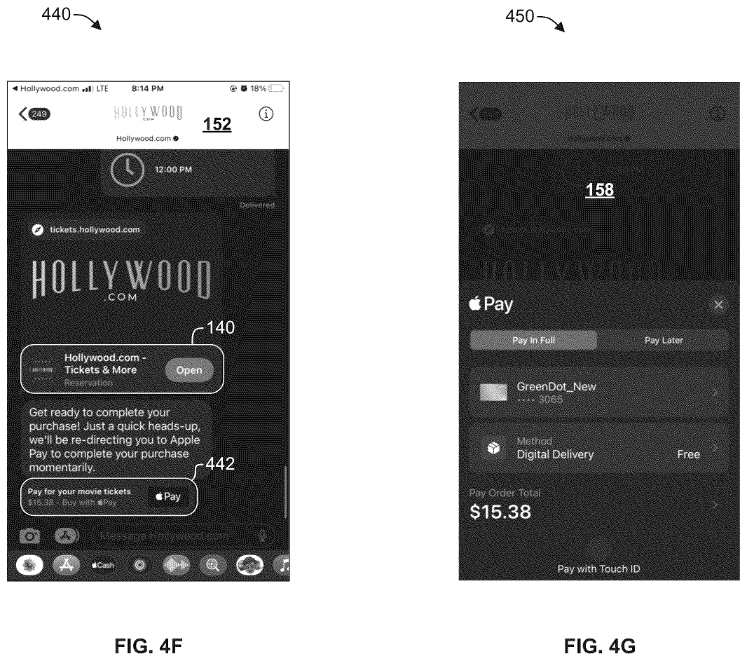

The client application 154 may include and/or be associated with the App Clip(s) 156 for seat selection and/or ticket selection. The App Clip(s) 156 may enable purchasing one or more tickets (e.g., movie ticket(s)) using the messaging application 152. The App Clip(s) 156 may be used to present a ticket selection interface (e.g., a ticket selection interface 402 illustrated in FIG. 4B) and/or a seat selection interface (e.g., a seat selection interface 410 illustrated in FIG. 4C) to a user. The App Clip(s) 156 may include a Reserved Seat Selection (“RSS”) App Clip 204 (see FIG. 2). FIGS. 4A-4E illustrate example interfaces that may be displayed by the RSS App Clip 204 to a user, in accordance with at least one embodiment. FIG. 4F illustrates an example interface 440 that may be displayed by the messaging application 152 to a user, in accordance with at least one embodiment. FIG. 4G illustrates an example interface 450 that may be displayed by the payment application 158 to a user, in accordance with at least one embodiment.

Referring to FIG. 1, the messaging application 134 may send a message that includes a link 140 (see FIG. 4F) via the messaging service 110 to the messaging application 152 implemented by a particular one of the client device(s) 104. The messaging application 152 may cause the user interface 146 of the particular client device to display the message and the link 140 to the user associated with the particular client device (e.g., in the interface 440). The associated user may select the link 140 (e.g., by clicking on the link 140), which causes the particular client device to launch the RSS App Clip 204, which may communicate with the messaging application 152 (e.g., via communication functionality 202 illustrated in FIG. 2). By way of a non-limiting example, the communication functionality 202 may be implemented as an Application Programming Interface (“API”), application, service, and/or the like. The instructions 148, when performed by the processor(s) 142, may implement the communication functionality 202.

The RSS App Clip 204 (see FIG. 2) displays an initial screen or interface 400 (e.g., after a splash screen) to the user associated with the client device (of the client device(s) 104) performing the RSS App Clip 204. FIG. 4A is an illustration of an example of the initial interface 400, in accordance with at least one embodiment. The initial interface 400 may include a seat map 401 depicting available seats before the user has selected any seats.

Referring to FIG. 4B, after the associated user indicates that the user would like to select one or more tickets, (e.g., by selecting one or more seats using the seat map 401), the RSS App Clip 204 may display a ticket selection interface 402 (e.g., a popup) to the user that the associated user may use to select ticket(s). The ticket selection interface 402 may allow the associated user to select a particular theater and/or may display tickets for a particular theater (e.g., a theater chosen by the associated user). If the seats are to be reserved, the user may also select for which the seat(s) the user would like to purchase ticket(s). When this occurs, the RSS App Clip 204 may display the seat selection interface 410 (see FIG. 4C). The seat selection interface 410 may display a dynamic seat map 412 (see FIG. 4C) that allows the user to select or reserve one or more seats. The RSS App Clip 204 may accurately report user selected choices to the server application 138 through the client application 154 (e.g., by using an API 206 illustrated in FIG. 2) to complete the correct purchase.

Referring to FIG. 4D, after the user completes the selection process and indicates the user would like to purchase the ticket(s), the RSS App Clip 204 may display a checkout interface 420 to the user. The checkout interface 420 may display a message to the user (e.g., “Get Ready! You'll be directed to Apply Pay checkout in seconds . . . ”). Then, referring to FIG. 4E, the RSS App Clip 204 may display an interface 430 to the user that displays a message (e.g., “Hooray! Tickets created successfully”). Next, referring to FIG. 4F, the user is directed to the messaging application 152, which displays an interface 440 to the user. In other words, the ticket selection interface 402, the seat selection interface 410, and/or the RSS App Clip 204 may close or otherwise return the associated user to the messaging application 152, which may guide the user through the payment process using the client application 154. Thus, after seat selection, the RSS App Clip 204 returns the user to the messaging application 152.

The RSS App Clip 204 and/or the server application 138 may send a message (e.g., with a prompt and/or link) to the messaging application 152, which displays the message to the user. For example, the interface 440 may display a message (e.g., “Get ready to complete your purchase! Just a quick heads-up, we'll be redirecting you to Apple Pay to complete your purchase momentary.”). The message may inform the user to use the payment application 158 (e.g., Apple Pay) to complete the transaction. The RSS App Clip 204 may notify the server application 138 (e.g., via the client application 154, the messaging application 152, the API(s) 206, and/or the webhook) that the user would like to purchase the ticket(s). The messaging application 134 may send a message that includes a link 442 (see FIG. 4F) via the messaging service 110 to the messaging application 152 for display thereby in the interface 440. Alternatively or additionally, the RSS App Clip 204 may provide the link 442 to the interface 440. When the user selects the link 442, the user may access the payment application 158, which may be launched by the user selecting the link 442.

For payment processing, the server application 138 may include and/or communicate with a Payment Processing gateway (not shown) and/or gateway application 136. Using the payment application 158, the user may choose a payment method (e.g., from their Apple Wallet), which may cause a payment token to be posted to the gateway application 136 and/or the Payment Processing gateway (not shown). Then, the gateway application 136 may process the payment and initiate the order process with a Point-of-Sale (POS) system 160 associated with the selected theater.

The system 100 may allow dynamic use of the RSS App Clip 204 to select and/or reserve seats during a ticket purchase. The RSS App Clip 204 may communicate in real time with the server application 138 that provides availability of seats and a location for each seat available for purchase. The RSS App Clip 204 may use this information to generate the seat map 412 (see FIG. 4C), which may accurately show where (in the venue location of choice) seat(s) is/are located, indicate availability of such seat(s), and indicate a seat type (e.g., handicap accessible, child ticket, adult, recliner seating, etc.) for each seat.

FIG. 2 is a block diagram illustrating example communications 200 used when the RSS App Clip 204 is used to purchase tickets, in accordance with at least one embodiment. FIG. 2 illustrates example components installed on the client device(s) 104, including the (client) messaging application 152, the communication functionality 202, the RSS App Clip 204, an API 206, and the client application 154.

Purchasing one or more tickets may begin with the messaging application 152 receiving a selection of a particular event for which the ticket(s) are to be purchased from a user. For example, purchasing one or more movie tickets may begin with the messaging application 152 receiving a selection of a particular showtime for a movie at a particular theater from a user. The messaging application 152 may communicate (represented by an arrow 210) this selection to the communication functionality 202, which, referring to FIG. 1 may communicate the selection to the server application 138 (e.g., via the messaging service 110). Referring to FIG. 4F, in response to receiving this communication, the server application 138 may generate the link 140 (e.g., URL) and send the link 140 in a message (e.g., a text message) to the messaging application 152 (e.g., via the messaging service 110). The messaging application 152 displays the link 140 to the user.

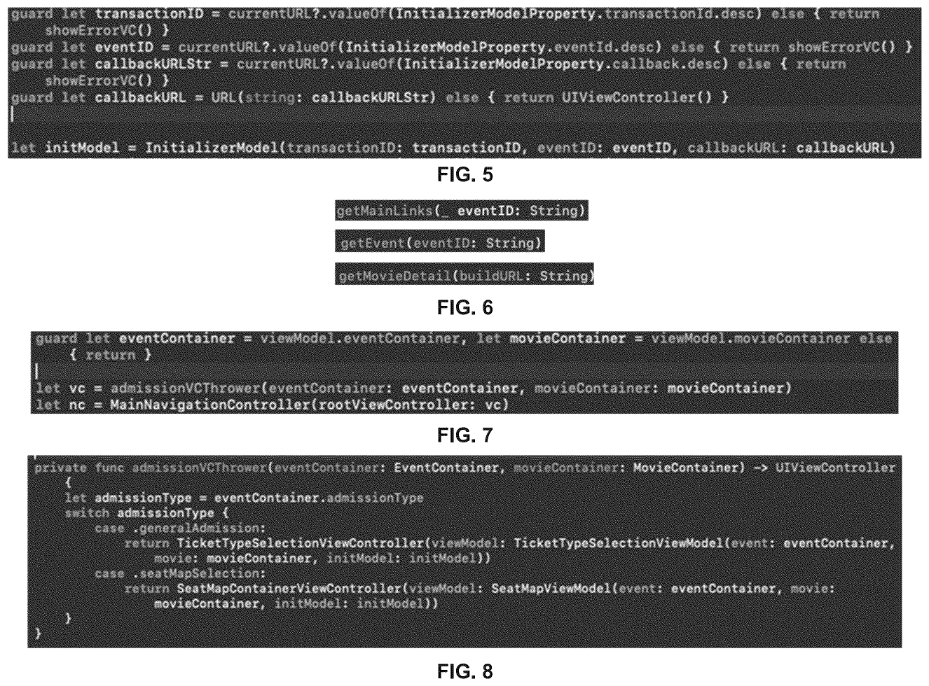

After the user selects the link 140, the messaging application 152 launches (represented by an arrow 212) the RSS App Clip 204 and passes information to the RSS App Clip 204. The launched RSS App Clip 204 may begin loading and displaying a “Splash screen” to the user. The information passed to the RSS App Clip 204 may include the link 140, which may include a TransactionId, an Eventld, and a WebHookURL. Each of the transactionId, the Eventld, and the WebHookURL may be implemented as strings. When the RSS App Clip 204 is launched or triggered, the RSS App Clip 204 detects that it was delivered via the link 140 or otherwise caused to launch by the link 140. Then, the RSS App Clip 204 divides and/or parses the link 140 into parts according to any needs of the RSS App Clip 204 and uses those parts to generate an initializer model. FIG. 5 depicts a code segment that may be used to perform these tasks, in accordance with at least one embodiment. In FIG. 5, a variable “currentURL” refers to the link 140 and the RSS App Clip 204 parses the link 140 to obtain values for variables “transactionId,” “eventId,” and “callBack.” The value of the variable “callback” may store the WebHookURL. Then, the RSS App Clip 204 initializes the initializer model with these values.

Next, the RSS App Clip 204 uses (represented by an arrow 214) the API 206 to obtain information using the values parsed from the link 140. For example, the RSS App Clip 204 may call functions getEvent (EventId), getSeatMap (EventId), and getTicketTypes (EventId), which each include the value of the variable “eventId” as an input parameter. FIG. 6 depicts a code segment that may be used to perform these tasks, in accordance with at least one embodiment. The main links of the API 206 may be “called” meaning “invoked,” and when this returns successfully, the event details (e.g., movie details) are filled in correctly based on the value of the variable “eventID.” In other words, the RSS App Clip 204 calls a function getMainLinks (EventId) of the API 206 to verify that the value of the variable “eventId” is valid. Then, if the value of the variable “eventId” is valid, the RSS App Clip 204 calls functions getEvent (EventId) and getMovieDetail (BuildUrl) to obtain information to use to populate the ticket selection interface 402 (e.g., a sales ticket screen). The RSS App Clip 204 may also use the API 206 to subscribe to an event websocket. The event websocket may provide updates to the RSS App Clip 204 with respect to ticket and/or seat availability.

Next, the API 206 responds (represented by an arrow 216) with the requested information. When the RSS App Clip 204 has received the information from the API 206 (e.g., the “calls” are completed), the RSS App Clip 204 transitions a “Splash screen” into a loading Finished state. When the “Splash screen” reaches the loading Finished state, the RSS App Clip 204 opens (represented by an arrow 218) the initial interface 400 and may populate it with at least some of the requested information. After the user uses the initial interface 400 to indicate that the user would like to purchase ticket(s), the RSS App Clip 204 opens the ticket selection interface 402 (e.g., the sales ticket screen) and may populate it with at least some of the requested information. FIG. 7 depicts a code segment that may be used to perform these tasks, in accordance with at least one embodiment. Thus, after the RSS App Clip 204 is launched, the RSS App Clip 204 displays the initial interface 400. After the user uses initial interface 400 to indicate that the user would like to select one or more tickets, the RSS App Clip 204 displays the ticket selection interface 402.

The ticket selection interface 402 receives (represented by the arrow 218) a selection of one or more tickets from the user. The ticket(s) each have a ticket type, such as general admission or reserved seating. In other words, when the user selects the ticket(s), the user chooses a value of a variable “admissionType,” which corresponds to a ticketing method for the event corresponding to the value of the variable “eventId.” Based upon ticket type, the RSS App Clip 204 decides which interface (e.g., screen) to generate and display (represented by the arrow 218) to the user. FIG. 8 depicts a code segment that may be used to perform these tasks, in accordance with at least one embodiment.

For general admission, the RSS App Clip 204 need only generate and display the ticket selection interface 402, which lists the ticket types available (e.g., provided by the event websocket) and optionally a quantity of each ticket type available. To purchase general admission type tickets, the user selects ticket quantities with respect to one or more of the available general admission ticket types.

For reserved seating, the RSS App Clip 204 generates and displays the seat selection interface 410 (e.g., as a popup) that includes the seat map 412, which may be updated in real-time using updates provided by the event websocket. FIG. 4C is an illustration of an example of the seat selection interface 410 (e.g., a Seat Map Ticket Selection Screen) that includes the seat map 412, in accordance with at least one embodiment.

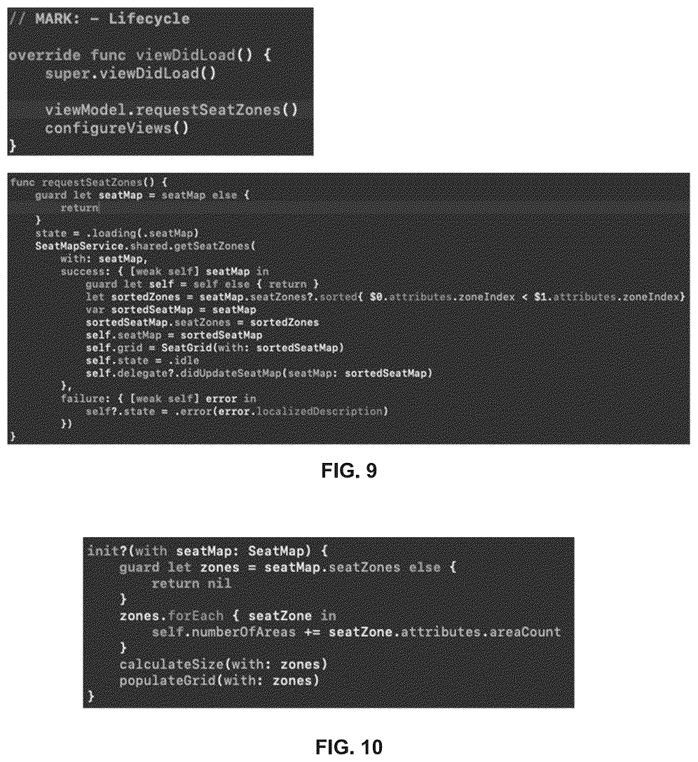

When the seat selection interface 410 is opened, the RSS App Clip 204 uses the API 206 to call a seat zones service (e.g., provided by the server application 138 and/or the client application 154) to obtain information to populate the seat map 412. FIG. 9 depicts a code segment that may be used to perform these tasks, in accordance with at least one embodiment.

As detailed in the code segment of FIG. 9, the RSS App Clip 204 may create a “SeatGrid” using the information collected previously and calculation methods provided in an initial part of this process. FIG. 10 depicts a code segment that may be used to perform these tasks, in accordance with at least one embodiment.

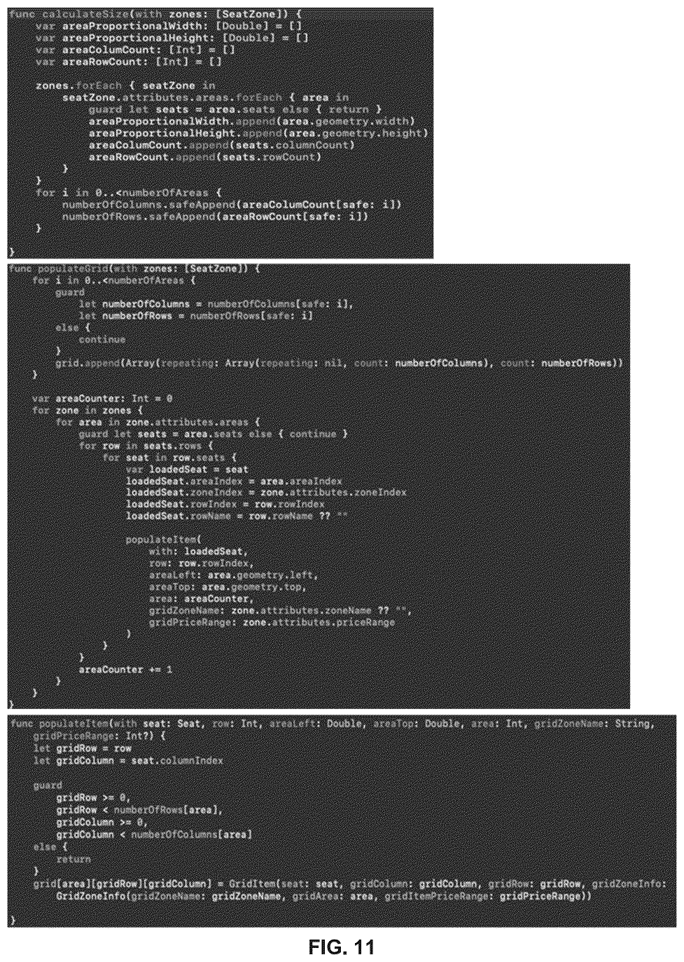

According to the details received from the API 206, the RSS App Clip 204 receives seat zone information (e.g., from the API 206), calculates sizes of the seat zones, and draws the seat zones in the seat selection interface 410. FIG. 11 depicts a code segment that may be used to perform these tasks, in accordance with at least one embodiment.

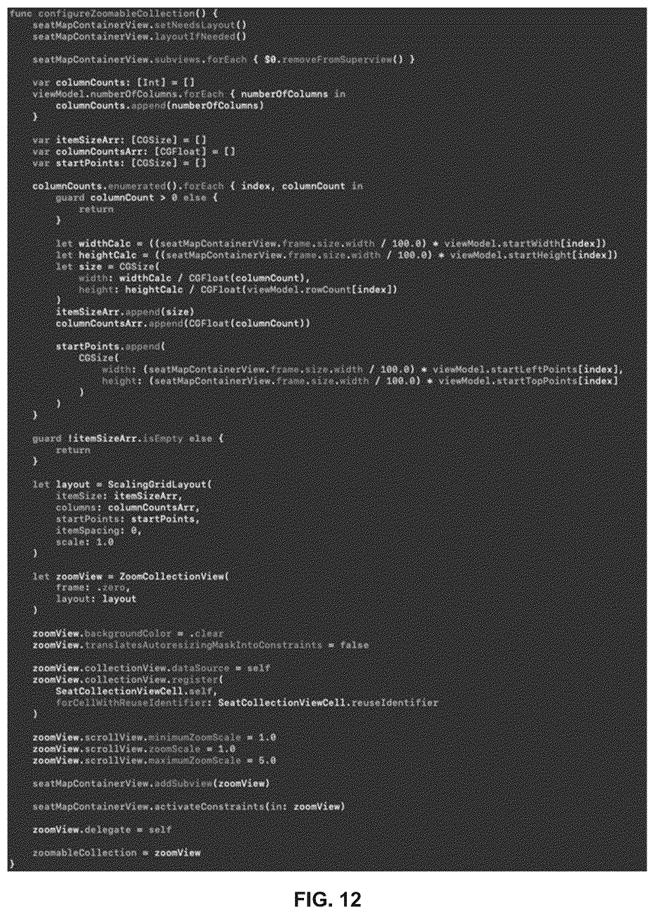

The RSS App Clip 204 receives code (e.g., from the API 206) that allows this data collection (e.g., seats in each zone) to grow or shrink. This place is specified in zoomableCollection. FIG. 12 depicts a code segment that may be used to perform these tasks, in accordance with at least one embodiment.

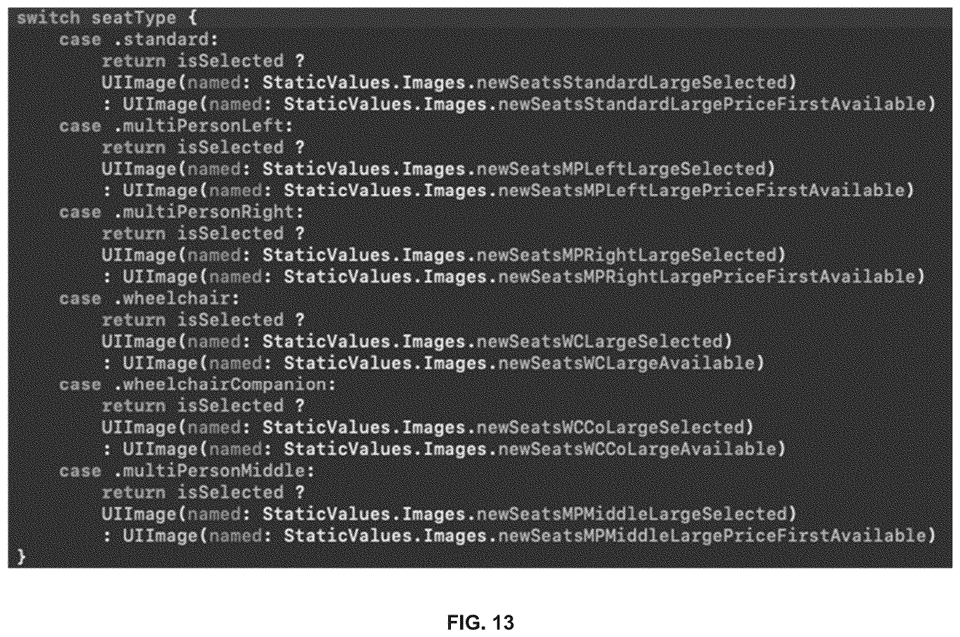

To draw the seat map 412, the RSS App Clip 204 receives the “zones” and “seats” located in these zones via the API 206. The RSS App Clip 204 receives and displays different types of seats in the seat map 412 of the seat selection interface 410 according to the seat types in these zones. FIG. 13 depicts a code segment that may be used to perform these tasks, in accordance with at least one embodiment.

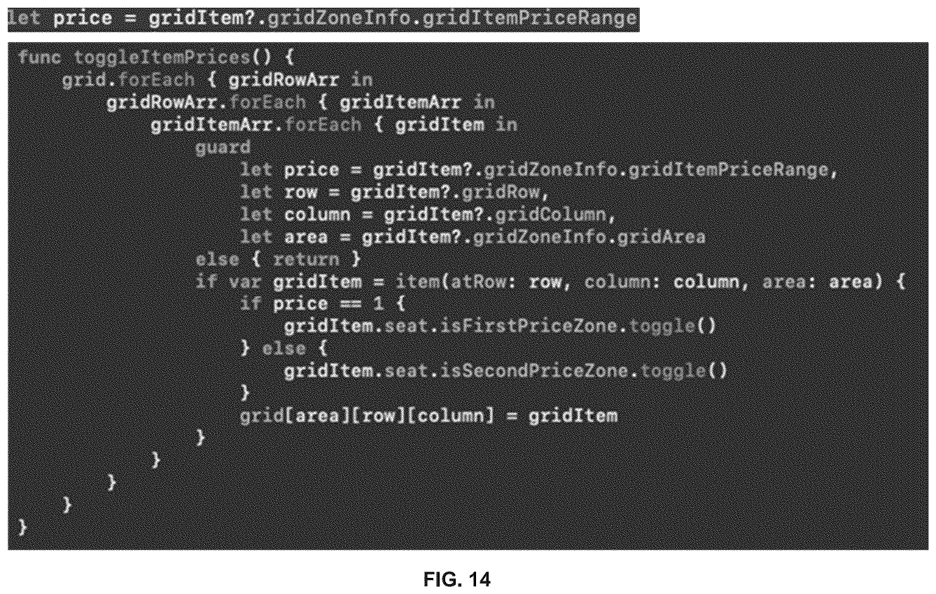

The RSS App Clip 204 displays different ticket prices and icons with dollar signs that may be triggered or selected by the user (e.g., to initiate a purchase of one or more seats displayed within the seat map 412). How this information is displayed may be determined based at least in part on data coming from within the zones. The RSS App Clip 204 may be triggered to display the information by the user selecting a button to display price zone prices. FIG. 14 depicts a code segment that may be used to perform these tasks, in accordance with at least one embodiment.

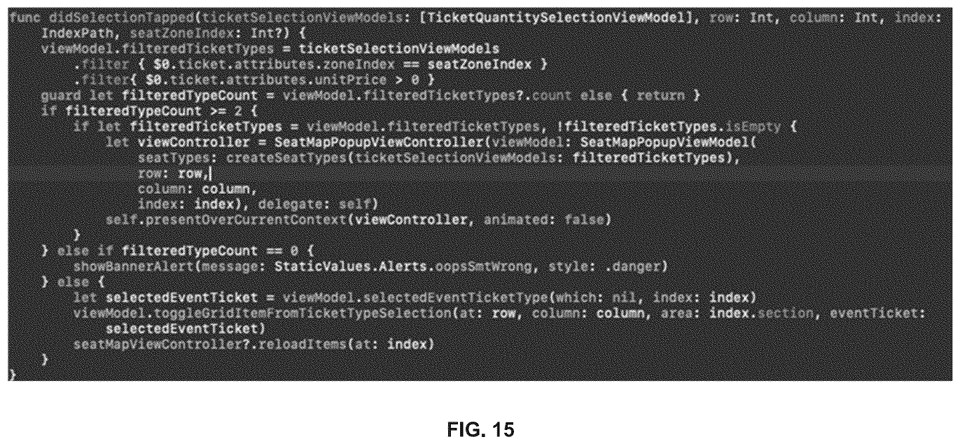

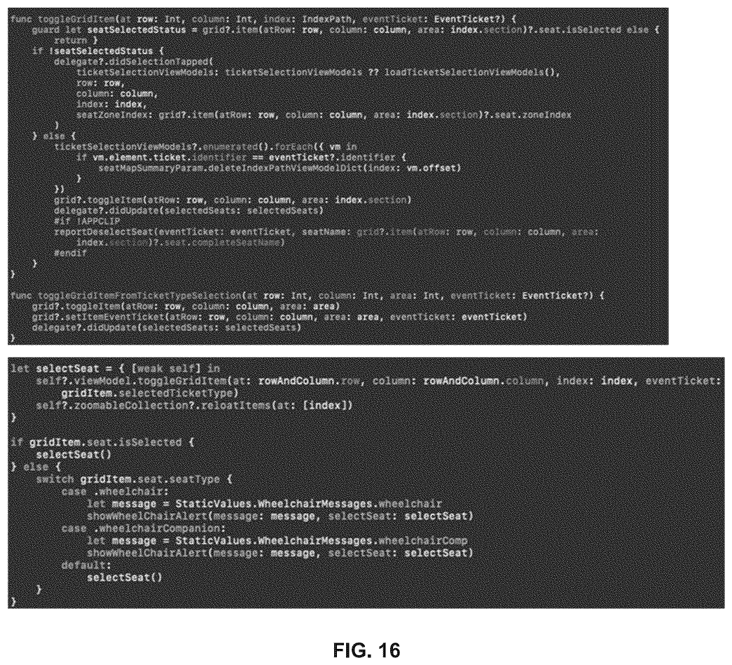

Referring to FIG. 2, the RSS App Clip 204 displays the seat selection interface 410 (e.g., as a popup) and the user may use the seat selection interface 410 to select ticket types collected from the server application 138 (see FIG. 1). FIG. 15 depicts a code segment that may be used to perform these tasks, in accordance with at least one embodiment. The seat selection interface 410 processes this information and displays an unlimited number of ticket types to the user.

After a seat is selected (e.g., by the user selecting or clicking on an image representing or depicting the seat in the seat map 412), the RSS App Clip 204 marks the selected seat (e.g., in the seat map 412), even if it is a single type of ticket, and may change the color of the depiction of selected seat in the seat map 412 (e.g., to golden). On the other hand, if the user unselects or deselects a seat, the RSS App Clip 204 returns the seat to the initial state and the selection is canceled. After this selection/deselection, the ticket prices, selected tickets, and taxes fields of the seat selection interface 410 (e.g., a screen) are updated. FIG. 16 depicts a code segment that may be used to perform at least some of the aforementioned these tasks, in accordance with at least one embodiment.

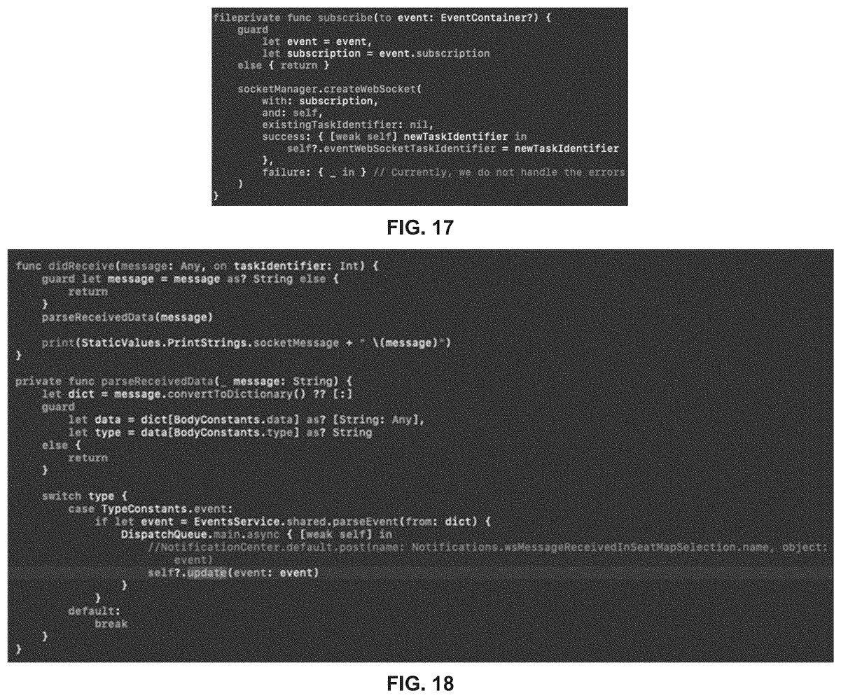

In addition, the RSS App Clip 204 may include a mechanism that allows ticket and/or seat availability to be instantly updated on the seat selection interface 410 (see FIG. 4C) when tickets are purchased/reserved by other users. This mechanism includes the RSS App Clip 204 listening to an instantly updated event websocket on the computing system 102 (e.g., operated by the server application 138). When the seat selection interface 410 is opened, a websocket connection is established with the necessary information. FIG. 17 depicts a code segment that may be used to perform at least some of the aforementioned these tasks, in accordance with at least one embodiment.

Each time the RSS App Clip 204 receives a message (e.g., via the websocket connection), the RSS App Clip 204 parses the message and the information in the seat selection interface 410 is updated. FIG. 18 depicts a code segment that may be used to perform at least some of the aforementioned these tasks, in accordance with at least one embodiment.

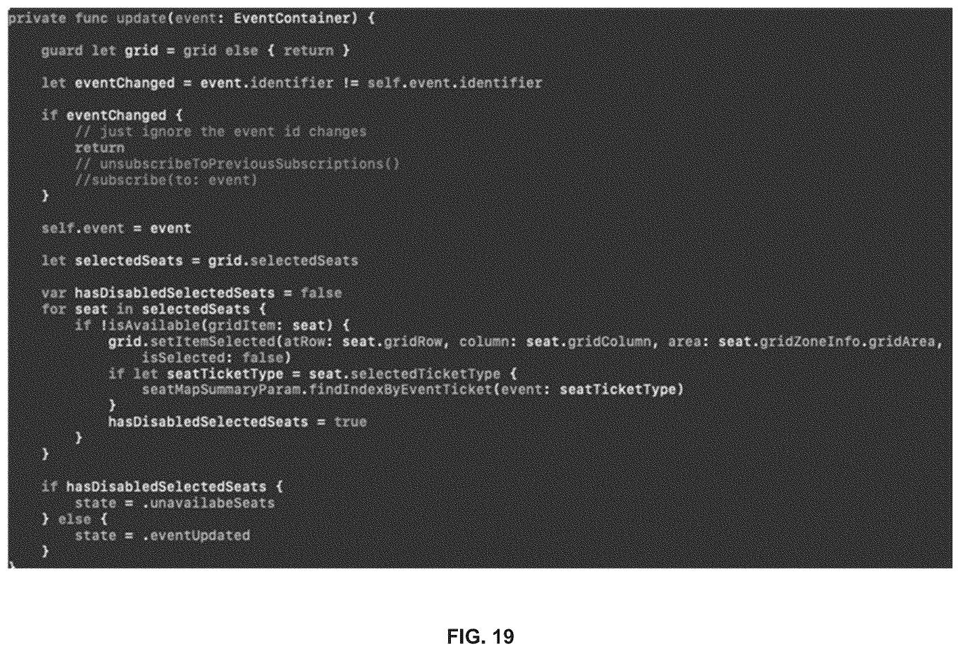

When the information in the message indicates a change has occurred, if there are seat status changes, the RSS App Clip 204 modifies the seat map 412 on the seat selection interface 410 to reflect these changes. In this manner, the RSS App Clip 204 may provide automatic updating to reflect the real time status of the seats for the selected event (e.g., movie showtime at the selected theater). FIG. 19 depicts a code segment that may be used to perform at least some of the aforementioned these tasks, in accordance with at least one embodiment.

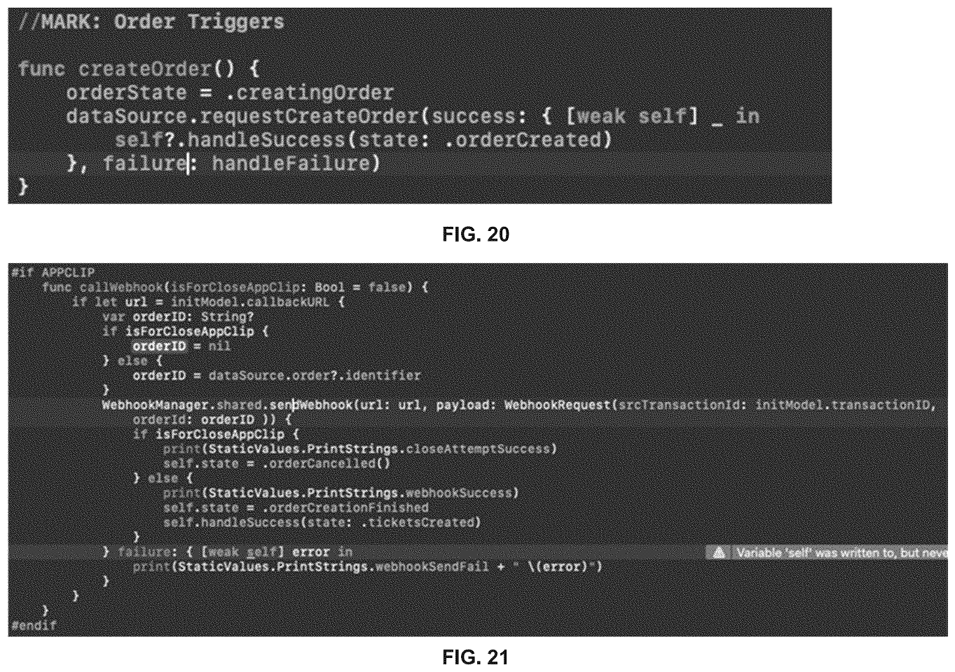

The choices made by the user are communicated to the server application 138 and the seats are reserved. FIG. 20 depicts a code segment that may be used to perform at least some of the these aforementioned tasks, in accordance with at least one embodiment.

The RSS App Clip 204 sends the selections for the current order to the server application 138 via the webhook and the messaging application 152 is notified by the RSS App Clip 204 (e.g., via the communication functionality 202) of the selections made by the user. FIG. 21 depicts a code segment that may be used to perform at least some of the aforementioned these tasks, in accordance with at least one embodiment. Referring to FIG. 2, the RSS App Clip 204 sends (represented by an arrow 218) a request to create an order to the API 206 (e.g., using a function createOrder ( ) of the API 206). Then, the RSS App Clip 204 receives (represented by an arrow 220) order information (e.g., an orderID and/or other information) from the API 206. The RSS App Clip 204 may also subscribe to an order websocket which may provide updated order information to the RSS App Clip 204 (e.g., for display thereby). Next, the RSS App Clip 204 may send updates to the order (e.g., using a function updateOrder of the API 206). The function updateOrder may include input parameters OrderID (e.g., a string) and tickets (e.g., a list).

At this point, the RSS App Clip 204 may wait and/or show progress (represented by an arrow 222) to the user (e.g., by showing the interfaces 420 and/or 430). The RSS App Clip 204 receives (represented by an arrow 224) the order information (e.g., the orderId and/or other information) from the API 206 (e.g., in a message from the order websocket). The RSS App Clip 204 sends (represented by an arrow 226) at least some of the order information to the communication functionality 202, which communicates at least some of the order information to the server application 138 (e.g., using the webhook and/or the communication functionality 202) and/or the messaging application 152 (e.g., using the communication functionality 202). At least some of the order information may be sent to the server application 138 as a Webhook Order that identifies the tickets, transactionId, and/or orderId. Then, the RSS App Clip 204 may close and return the user back to the messaging application 152 (e.g., which may display the interface 440 illustrated in FIG. 4F). The communication functionality 202 receives order information (e.g., the transactionId and/or the orderId) from the RSS App Clip 204 and communicates (represented by an arrow 228) the order information to the messaging application 152. Then, the communication functionality 202 receives order confirmation information (e.g., from the server application 138 and/or the client application 154) and communicates (represented by an arrow 230) the order confirmation information to the messaging application 152 for display thereby (e.g., in the interface 440). The order confirmation information may confirm tickets and/or payment processing.

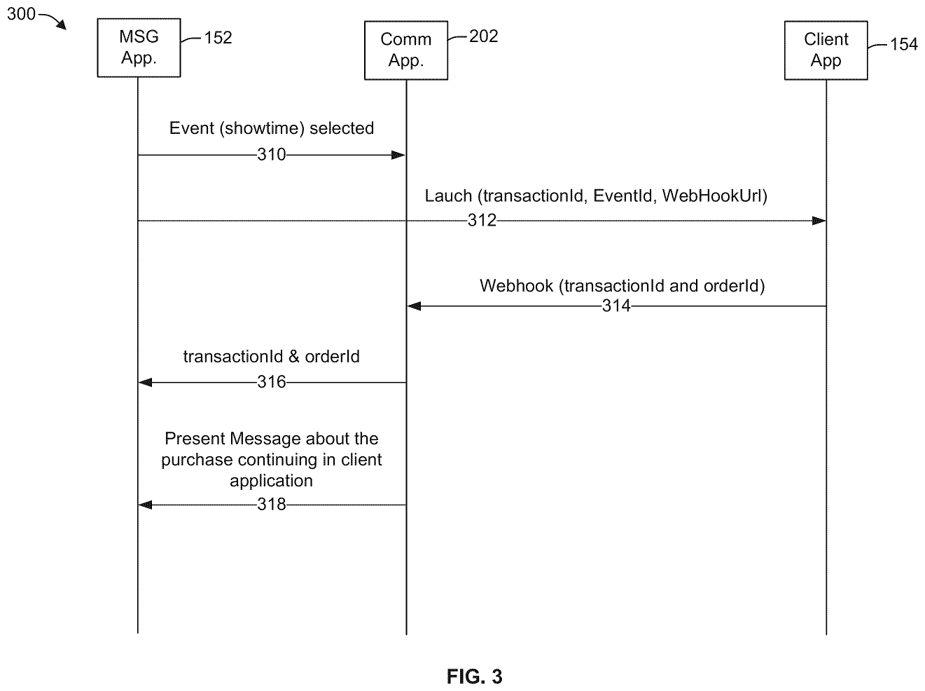

FIG. 3 is a block diagram illustrating example communications 300 used when the client application 154 is used to purchase tickets, in accordance with at least one embodiment. FIG. 3 illustrates example components installed on the client device(s) 104, including the (client) messaging application 152, the communication functionality 202, and the client application 154.

Ticket purchasing may begin with the messaging application 152 receiving a selection of a particular event (e.g., at a particular location) from a user. For example, purchasing one or more movie tickets may start with the messaging application 152 receiving a selection of a particular showtime for a movie at a particular theater from a user. The messaging application 152 may communicate (represented by an arrow 310) this selection to the communication functionality 202, which may communicate the selection to the server application 138 (e.g., via the messaging service 110). In response to receiving this communication, the server application 138 may generate a link (e.g., like the link 140) and send the link in a message (e.g., a text message) to the messaging application 152 (e.g., via the messaging service 110). The messaging application 152 displays the link to the user.

After the user selects the link, the messaging application 152 communicates with and/or launches (represented by an arrow 312) the client application 154 and passes information to the client application 154. The launched client application 154 may begin loading and displaying a “Splash screen” to the user. The information passed to the client application 154 may include the link, which may include a TransactionId, an EventId, and a WebHookURL. Each of the transactionId, the EventId, and the WebHookURL may be implemented as strings. When the client application 154 is launched or triggered, the client application 154 detects that it was launched by the link or otherwise caused to launch by the link. Then, the client application 154 divides and/or parses the link into parts according to any needs of the client application 154. The client application 154 may validate the eventId and/or obtain event details (e.g., movie details) based on the value of the variable “eventID.” At this point, the client application 154 may transition a “Splash screen” into a loading Finished state, open an initial interface like the initial interface 400, and populate the initial interface with the appropriate information. The client application 154 may use at least some of the information obtained using the link to populate the initial interface. After the user uses the initial interface to indicate that the user would like to purchase ticket(s), the client application 154 may use at least some of this information to populate a ticket selection interface like the ticket selection interface 402. The client application 154 may also subscribe to an event websocket that provides updates to the client application 154 with respect to ticket and/or seat availability.

Next, the ticket selection interface receives a selection of one or more tickets from the user. Based upon ticket type, the client application 154 decides which interface (e.g., screen) to generate and display to the user. For general admission, the client application 154 need only generate and display the ticket selection interface, which lists the ticket types available (e.g., provided by the event websocket) and optionally a quantity of each ticket type available. To purchase general admission type tickets, the user selects ticket quantities with respect to one or more of the available general admission ticket types. For reserved seating, the client application 154 generates and displays a seat selection interface like the seat selection interface 410 that includes a seat map like the seat map 412. The seat map may be updated in real-time using updates provided by the event websocket. The client application 154 may call a seat zones service (e.g., provided by the server application 138) to obtain information to populate the seat map. To draw the seat map, the client application 154 receives the “zones” and “seats” located in these zones (e.g., from the event websocket and/or the server application 138). The client application 154 receives and displays different types of seats in the seat map according to the seat types in these zones.

The client application 154 displays different ticket prices and icons with dollar signs that may be triggered or selected by the user (e.g., to initiate a purchase of one or more seats displayed within the seat map). How this information is displayed may be determined based at least in part on data coming from within the zones. The client application 154 may be triggered to display the information by the user selecting a button to display price zone prices. The client application 154 may display the seat selection interface and the user may use the seat map of the seat selection interface to select ticket types collected from the server application 138 (see FIG. 1). After selection and/or deselection of one or more seats, the ticket prices, selected tickets, and taxes fields of the seat selection interface (e.g., a screen) are updated.

Each time the client application 154 receives a message (e.g., via the websocket connection), the client application 154 updates the seat selection interface using information included in the message. In this manner, the client application 154 may provide automatic updating to reflect the real time status of the seats for the selected event (e.g., movie showtime at the selected theater).

The client application 154 sends the selections for the order information (e.g., transactionId and orderId) to the server application 138 via the webhook and the communication functionality 202 (represented by an arrow 314). Thus, the choices made by the user are communicated to the server application 138 and the seats are reserved. The client application 154 may also subscribe to an order websocket, which may provide updated order information to the client application 154 (e.g., for display thereby).

The communication functionality 202 communicates at least some of the order information to the server application 138 (e.g., using the webhook and/or the communication functionality 202). At least some of the order information may be sent to the server application 138 as a Webhook Order that identifies the tickets, transactionId, and/or orderId. The communication functionality 202 communicates (represented by an arrow 316) at least some of the order information (e.g., the transactionId and/or the orderId) to the messaging application 152. Then, the communication functionality 202 sends (represented by an arrow 318) a message to the messaging application 152 for display thereby (e.g., in an interface like the interface 440) informing the user that the purchase will continue in client application 154. Optionally, the communication functionality 202 may receive order confirmation information (e.g., from the server application 138 and/or the client application 154) and communicates the order confirmation information to the messaging application 152 for display thereby. The order confirmation information may confirm tickets and/or payment processing.

### Computing Device

FIG. 22 is a diagram of hardware and an operating environment in conjunction with which implementations of the one or more computing devices of the system 100 may be practiced. The description of FIG. 22 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those of ordinary skill in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments (e.g., cloud computing platforms) where tasks are performed by remote processing devices that are linked through a communications network. In a distributed computing environment, program modules may be located in both local and remote memory storage devices.

The exemplary hardware and operating environment of FIG. 22 includes a general-purpose computing device in the form of the computing device 12. Each of the computing devices of FIG. 1 (including the computing system 102, the client device(s) 104, the computing system 108, and/or the computing system 112) may be substantially identical to the computing device 12 and/or implemented using one or more computing devices like the computing device 12. By way of non-limiting examples, the computing device 12 may be implemented as a laptop computer, a tablet computer, a web enabled television, a personal digital assistant, a game console, a smartphone, a mobile computing device, a cellular telephone, a desktop personal computer, and the like.

The computing device 12 includes a system memory 22, the processing unit 21, and a system bus 23 that operatively couples various system components, including the system memory 22, to the processing unit 21. There may be only one or there may be more than one processing unit 21, such that the processor of computing device 12 includes a single central-processing unit (“CPU”), or a plurality of processing units, commonly referred to as a parallel processing environment. When multiple processing units are used, the processing units may be heterogeneous. By way of a non-limiting example, such a heterogeneous processing environment may include a conventional CPU, a conventional graphics processing unit (“GPU”), a floating-point unit (“FPU”), combinations thereof, and the like.

The computing device 12 may be a conventional computer, a distributed computer, or any other type of computer.

The system bus 23 may be any of several types of bus structures including a memory bus or memory controller, a peripheral bus, and a local bus using any of a variety of bus architectures. The system memory 22 may also be referred to as simply the memory, and includes read only memory (ROM) 24 and random access memory (RAM) 25. A basic input/output system (BIOS) 26, containing the basic routines that help to transfer information between elements within the computing device 12, such as during start-up, is stored in ROM 24. The computing device 12 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules, and other data for the computing device 12. It should be appreciated by those of ordinary skill in the art that any type of computer-readable media which can store data that is accessible by a computer, such as magnetic cassettes, flash memory cards, solid state memory devices (“SSD”), USB drives, digital video disks, Bernoulli cartridges, random access memories (RAMs), read only memories (ROMs), and the like, may be used in the exemplary operating environment. As is apparent to those of ordinary skill in the art, the hard disk drive 27 and other forms of computer-readable media (e.g., the removable magnetic disk 29, the removable optical disk 31, flash memory cards, SSD, USB drives, and the like) accessible by the processing unit 21 may be considered components of the system memory 22.

A number of program modules may be stored on the hard disk drive 27, magnetic disk 29, optical disk 31, ROM 24, or RAM 25, including the operating system 35, one or more application programs 36, other program modules 37, and program data 38. A user may enter commands and information into the computing device 12 through input devices such as a keyboard 40 and pointing device 42. Other input devices (not shown) may include a microphone, joystick, game pad, satellite dish, scanner, touch sensitive devices (e.g., a stylus or touch pad), video camera, depth camera, or the like. These and other input devices are often connected to the processing unit 21 through a serial port interface 46 that is coupled to the system bus 23, but may be connected by other interfaces, such as a parallel port, game port, a universal serial bus (USB), or a wireless interface (e.g., a Bluetooth interface). A monitor 47 or other type of display device is also connected to the system bus 23 via an interface, such as a video adapter 48. In addition to the monitor, computers typically include other peripheral output devices (not shown), such as speakers, printers, and haptic devices that provide tactile and/or other types of physical feedback (e.g., a force feedback game controller).

The input devices described above are operable to receive user input and selections. Together the input and display devices may be described as providing a user interface.

The computing device 12 may operate in a networked environment using logical connections to one or more remote computers, such as remote computer 49. These logical connections are achieved by a communication device coupled to or a part of the computing device 12 (as the local computer). Implementations are not limited to a particular type of communications device. The remote computer 49 may be another computer, a server, a router, a network PC, a client, a memory storage device, a peer device or other common network node, and typically includes many or all of the elements described above relative to the computing device 12. The remote computer 49 may be connected to a memory storage device 50. The logical connections depicted in FIG. 22 include a local-area network (LAN) 51 and a wide-area network (WAN) 52. Such networking environments are commonplace in offices, enterprise-wide computer networks, intranets and the Internet. The network(s) 106 (see FIG. 1) may be implemented using one or more of the LAN 51 or the WAN 52 (e.g., the Internet).

Those of ordinary skill in the art will appreciate that a LAN may be connected to a WAN via a modem using a carrier signal over a telephone network, cable network, cellular network, or power lines. Such a modem may be connected to the computing device 12 by a network interface (e.g., a serial or other type of port). Further, many laptop computers may connect to a network via a cellular data modem.

When used in a LAN-networking environment, the computing device 12 is connected to the local area network 51 through a network interface or adapter 53, which is one type of communications device. When used in a WAN-networking environment, the computing device 12 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computing device 12, or portions thereof, may be stored in the remote computer 49 and/or the remote memory storage device 50. It is appreciated that the network connections shown are exemplary and other means of and communications devices for establishing a communications link between the computers may be used.

The computing device 12 and related components have been presented herein by way of particular example and also by abstraction in order to facilitate a high-level view of the concepts disclosed. The actual technical design and implementation may vary based on particular implementation while maintaining the overall nature of the concepts disclosed.

In some embodiments, the system memory 22 stores computer executable instructions that when executed by one or more processors cause the one or more processors to perform all or portions of one or more of the methods (including the methods illustrated in FIGS. 2 and 3) described above. Such instructions may be stored on one or more non-transitory computer-readable media.

In some embodiments, the system memory 22 stores computer executable instructions that when executed by one or more processors cause the one or more processors to generate the interfaces 400, 402, 410, 420, 430, 440, and 450 illustrated in FIGS. 4A, 4B, 4C, 4D, 4E, 4F, and 4G, respectively. Such instructions may be stored on one or more non-transitory computer-readable media.

At least one embodiment of the disclosure can be described in view of the following clauses.

Clause 1. A method comprising: transmitting, by a server application, a link to a messaging application performed by a client device, selection of the link in the messaging application to cause the client device to launch an abbreviated version of a client application, the abbreviated version to implement less than a full version of the client application; transmitting, by the abbreviated version of the client application, ticket selection information to the server application; and causing, by the abbreviated version of the client application, the messaging application to initiate a payment process.

Clause 2. The method of clause 1, further comprising: displaying, by the abbreviated version of the client application, a seat map depicting available seats; and updating, by the abbreviated version of the client application, the seat map based at least in part on one or more seat updates received from the server application.

Clause 3. The method of clause 1 or 2, further comprising: requesting, by the abbreviated version of the client application, creation of an order using an application programming interface (API) to communicate with the client application.

Clause 4. The method of any of clauses 1-3, further comprising: notifying, by the abbreviated version of the client application, the messaging application with respect to one or more seat selections identified in the ticket selection information.

Clause 5. The method of any of clauses 1-4, wherein a webhook is used to transmit the ticket selection information to the server application.

Clause 6. The method of any of clauses 1-5, further comprising: subscribing, by the abbreviated version of the client application, to a websocket that is to provide one or more updates to the abbreviated version of the client application with respect to at least one of ticket availability or seat availability.

Clause 7. The method of any of clauses 1-6, wherein the message application is a text messaging application.

Clause 8. The method of any of clauses 1-7, wherein the link is transmitted, by the server application, to the messaging application in response to an identification of an event received from the messaging application, and the ticket selection information is to identify one or more tickets to the event.

Clause 9. The method of any of clauses 1-8, wherein the abbreviated version of the client application is to transmit the ticket selection information by using an application programming interface (API) to communicate the ticket selection information to the client application on the client device, and the client application is to forward the ticket selection information to the server application.

Clause 10. The method of any of clauses 1-9, wherein the abbreviated version of the client application is an app clip.

Clause 11. The method of any of clauses 1-10, wherein the selection of the link is received by the messaging application from a user. Clause 12. A system comprising: one or more circuits to communicate with a server computer system over a network, the one or more circuits to: perform a messaging application to receive a link from the server computer system; and launch an abbreviated version of a client application in response to selection of the link in the messaging application, the abbreviated version to implement less than a full version of the client application, transmit ticket selection information to the server computer system, and cause the messaging application to initiate a payment process.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

As used herein, a term joining items in a series (e.g., the term “or,” the term “and,” or the like) does not apply to the entire series of items, unless specifically stated otherwise or otherwise clearly contradicted by context. For example, the phrase “a plurality of A, B, and C” (with or without the Oxford comma) refers to a subset including at least two of the recited items in the series. Thus, the phrase refers to (1) at least one A and at least one B but not C, (2) at least one A and at least one C but not B, (3) at least one B and at least one C but not A, and (4) at least one A and at least one B and at least one C. Similarly, the phrase “a plurality of A, B, or C” (with or without the Oxford comma) refers to a subset including at least two of the recited items in the series. Thus, this phrase also refers to (1) at least one A and at least one B but not C, (2) at least one A and at least one C but not B, (3) at least one B and at least one C but not A, and (4) at least one A and at least one B and at least one C.

By away of another example, Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood with the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B, and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context.

Accordingly, the invention is not limited except as by the appended claims.

1. A system comprising:
one or more circuits to communicate with a server computer system over a network, the one or more circuits to:
perform a messaging application to receive a link from the server computer system; and
launch an abbreviated version of a client application in response to selection of the link in the messaging application, the abbreviated version to implement less than a full version of the client application, transmit ticket selection information to the server computer system, and cause the messaging application to initiate a payment process.

2. A method comprising:
transmitting, by a server application, a link to a messaging application performed by a client device, selection of the link in the messaging application to cause the client device to launch an abbreviated version of a client application, the abbreviated version to implement less than a full version of the client application;
transmitting, by the abbreviated version of the client application, ticket selection information to the server application; and
causing, by the abbreviated version of the client application, the messaging application to initiate a payment process.

3. The method of claim 2, further comprising:
displaying, by the abbreviated version of the client application, a seat map depicting available seats; and
updating, by the abbreviated version of the client application, the seat map based at least in part on one or more seat updates received from the server application.

4. The method of claim 2, further comprising:
requesting, by the abbreviated version of the client application, creation of an order using an application programming interface (API) to communicate with the client application.

5. The method of claim 2, further comprising:
notifying, by the abbreviated version of the client application, the messaging application with respect to one or more seat selections identified in the ticket selection information.

6. The method of claim 2, wherein a webhook is used to transmit the ticket selection information to the server application.

7. The method of claim 2, further comprising:
subscribing, by the abbreviated version of the client application, to a websocket that is to provide one or more updates to the abbreviated version of the client application with respect to at least one of ticket availability or seat availability.

8. The method of claim 2, wherein the message application is a text messaging application.

9. The method of claim 2, wherein the link is transmitted, by the server application, to the messaging application in response to an identification of an event received from the messaging application, and the ticket selection information is to identify one or more tickets to the event.

10. The method of claim 2, wherein the abbreviated version of the client application is to transmit the ticket selection information by using an application programming interface (API) to communicate the ticket selection information to the client application on the client device, and the client application is to forward the ticket selection information to the server application.

11. The method of claim 2, wherein the abbreviated version of the client application is an app clip.

12. The method of claim 2, wherein the selection of the link is received by the messaging application from a user.
